(19) United States
(12) Patent Application Publication
(10) Pub. No.: US 2011/0157298 A1
(43) Pub. Date: Jun. 30, 2011

(54) SYSTEM FOR PROCESSING AND SYNCHRONIZING LARGE SCALE VIDEO CONFERENCING AND DOCUMENT SHARING

(76) Inventors: Tingxue Huang, Toronto (CA); Tie Hu, Scarborough (CA); Ruicao Mu, Richmond Hill (CA); Ke Hong, Toronto (CA)

(21) Appl. No.: 12/650,883

(22) Filed: Dec. 31, 2009

(51) Int. Cl. H04N 7/14; G06F 15/16

(52) U.S. Cl. 348/14.08; 709/203; 709/231; 348/E07.077

(57) ABSTRACT

A method to provide video conferencing includes receiving at a server a plurality of video streams or audio streams from a plurality of clients; selecting a subset of video streams or audio streams to be rendered on a video conferencing display screen; providing access to the remaining participants through one or more links to one or more additional display screens; and sending only streams of the subset to a client to avoid transmissions of the remaining streams.

This application claims priority to U.S. application Ser. Nos. 12/473,257; 12/473,259 and 12/473,263, all of which were filed on May 27, 2009, the contents of which are incorporated by reference.

### BACKGROUND

The invention relates to systems and methods for processing, streaming, or synchronizing a real time video conferencing and document sharing among multiple participants.

The evolution of the internet and World Wide Web (WWW) has made web conferencing an attractive option for people to meet online, to have video, voice, and text communications, and to view and collaborate on the same document remotely. Instead of traveling, each participant can run software and/or hardware (the conferencing client, the client) to enter a virtual conference room to see each other and discuss topics or documents. This requires each of the video conferencing clients to generate and send its own video images to other clients directly or over a conference server; and to receive video images from other participant clients. In prior art, the transmission of video images requires large bandwidth. In general, if a conference is held by N nodes (N people) via a central server, N×(N−1) channels of transmissions (streams) are required on the server; N channels of streams are required on each node. For example, if each video stream is of size 320×240 (about 65% of the size of a Youtube video), using a typical H.264 codec for transmission at 10 frames per second, such a video will be streamed at 192 Kbps. If there are 4 participants, each participant will send (upload) its own video to the server, and receive (download) 3 video streams of the other 3 participants. Each node will require a bandwidth of 192 Kbps uplink and 192 Kbps×3=576 Kbps downlink. A typical residential or small business internet user in US and Canada is getting just this capacity, which means a 4-node video conference is the limit for such a user. In the meantime the server needs to process 4×3×192 Kbps=2,304 Kbps which equals 2 Mbps. If the number of nodes goes up to 100, the server needs to handle 100×99×192 Kbps=1,900,800 Kbps which is 1900 Mbps bandwidth, in this event a single server is fast approaching its limit to handle large network traffic, not to mention each node will require a bandwidth of 192 Kbps downlink and 99×192 Kbps=19008 Kbps, which is prohibitive for any regular residential or business user.

Another common problem in conventional conferencing system is the lack of synchronization of video streams to each node. Given the fact that each node has different network conditions including speed, bandwidth, local application consumption, each will receive the streams at a different speed. In the event of sharing a document presented by a host, the node with low network speed may only receive page 4, while other nodes may be on page 8 already, the slower node will not be able to meaningfully participate in the conference that discusses page 8 in this example.

### SUMMARY

In one aspect, a method to provide video conferencing includes generating at a client a high quality video stream and a low quality video stream; receiving at a server a plurality of high quality and low quality video streams from a plurality of clients; and sending from the server to each client one high quality video stream and a plurality of low quality video streams.

In another aspect that shows conferencing participants through one or more display screens, a method to provide video conferencing includes receiving at a server a plurality of video streams or audio streams from a plurality of clients; selecting a subset of video streams or audio streams to be rendered on a video conferencing display screen; providing access to the remaining participants through one or more links to one or more additional display screens; and sending only streams of the subset to a client to avoid transmissions of the remaining streams.

In another aspect, a method to synchronize file sharing in a video conference includes periodically labelling each video stream or document sharing stream with a session identifier (ID) to synchronize the conference video streams; periodically reporting to a server the session ID being streamed to the client, and comparing a received session ID with a session ID uploaded by the host client and sending a correct session ID to a client whose session ID exceeds a pre-determined synchronization tolerance.

Implementation of the above aspects may include one or more of the following. The method includes sending the high quality video stream at a high frequency to enhance video quality. The method can send the low quality video stream at a low frequency to reduce bandwidth requirement. The method includes selecting at the client one participant's high quality video stream. The system can display at the client the low quality video for the remaining participant(s). The client can select one participant's high quality video stream. The video streams can be accessed through multiple screen pages, each page contains video images of a sub-set of participants. To save bandwidth, the system streams only video streams for the sub-set of participants. The system can display a link to access videos of participants on another page. The user can search for a selected participant and display a page containing the video stream of the selected participant. The client computer can detect audio silence at the client and not transmit the client's audio stream to the server. Similarly, the client computer can detect a video still at the client and not transmit the client's video stream to the server. The client can send a document or a file to the server for document sharing or file sharing. To synchronize the file sharing, the client can periodically label each video stream or document sharing stream with a session identifier (ID) to synchronize the conference video streams. Each client periodically reports the session ID being streamed to the client, and the server compares a received session ID with a session ID uploaded by the client. The server sends a correct session ID to a client whose session ID exceeds a pre-determined synchronization tolerance. The method includes allowing predetermined clients to send voice streams to the server; mixing the voice streams at the server; and distributing the voice streams to the clients.

In another aspect, a video conferencing system and method allow each conference participant to compose and send two streams of videos to a central conference server, one of which is high quality, high-frequency video, the other is low quality, low frequency video. The conference server enables each participant to select the display of one participant with high quality video, and to display each remaining participant in low quality video. The server further enables each participant to change the participant to be display at high quality during the conference. The system employs preloaded technique to display a limited number of participants per page, and allows participants to search or flip pages to display the desired participants. Progress indicators are built in every conference participants that are sent to the conference server periodically for the server to synchronize the conference with all participants.

Another aspect is the display of a large scale video conference being divided in multiple screen pages, each page contains video images of a smaller number of participants, and can be flipped over to another page, therefore in any given time, only video images of a much smaller number of participant will be streamed to a client. The client can search the desired participant by name of person, name of group, team ID etc, and then enter the result page that contains the video image of the desire participant.

Yet another aspect is the silence detection of voice, and still detection of video at the conferencing client, when silence and still are detected, the client will not send voice and/or video to the server, so no bandwidth is consumed at that moment. Another aspect is the session synchronization method between conferencing server and clients, and multiple clients. In the present invention, video and file sharing streams are labeled by a network module with series of session IDs. Each client periodically reports the session ID that is currently streamed to it, the server compares the received session ID with the session ID uploaded by the host client. If the session IDs are within a range of acceptable discrepancy, the server will not interfere the streaming. If one or more clients' session IDs are below a pre-defined tolerance, the server will interfere and stream the correct session ID, usually the session ID that is currently streamed up to the server by the hosting client, to the clients that are falling behind.

Still another aspect is the separate voice enabling method. At any time of the conferencing, only a pre-defined number of clients are allowed to upstream their voice to the server, the server will mix the voice locally and then stream the mixed voice stream to all the clients. The conferencing host decides which clients shall be enabled to speak (upstream their voice), and the remaining non-enabled clients are designated as listeners. A silence detection module is equipped on each client, so the client will only start upstream its voice when silence is not detected, the module can help reduce the bandwidth consumption at clients, and reduce the sound mix load at server end.

Advantages of the preferred embodiments may include one or more of the following. The system provides a method and system to intelligently process and synchronize multi client video conferencing and document sharing among a plurality of participants over internet to a central conferencing server. Each conferencing client generates and sends two video streams, one of high quality and high frequency, the other of low quality and low frequency, to the central conferencing server. The server sends only one stream of high quality video plus the rest streams of low quality videos to a client, among which the high quality video is the participant the client chooses to view predominantly, the low quality videos are the rest of participants. Each client can change the participant to view predominantly, accordingly, the server will stream the high quality video image of the selected participant, and stream low quality video images of the rest participants to the client.

### BRIEF DESCRIPTION OF THE DRAWINGS

FIG. 1 shows an exemplary diagram of a web conferencing and file sharing application over the internet.

FIG. 2 shows an exemplary diagram illustrating a signal and media stream between a server and a client in the web conferencing and file sharing system.

FIG. 3 shows a diagram illustrating a page division process to divide the display of conferencing participants into multiple pages.

FIG. 4 shows a diagram illustrating an exemplary result page after a search for participant is performed.

FIG. 5 shows a system diagram illustrating system modules of conferencing server and clients.

FIG. 6 shows a diagram illustrating the management and synchronization of web conferencing and file sharing sessions.

FIG. 7 shows an exemplary diagram illustrating a silence detection process on conferencing client

FIG. 8 is the diagram illustrating an exemplary voice enabling and mixing process in the conferencing system.

### DESCRIPTION

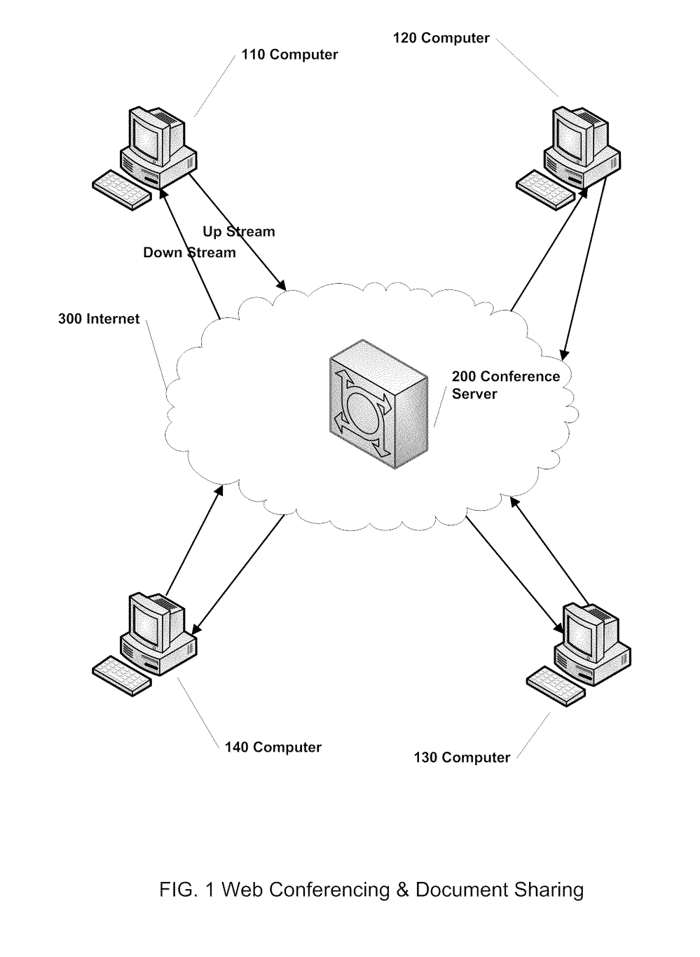

FIG. 1 shows an exemplary web conferencing and file sharing system. Multiple client computers 110, 120, 130 and 140 remotely connect to a conferencing server 200 over a wide area network (WAN) 300 such as the Internet. Each client computer 110-140 can be either a specialty conferencing device, or a general purpose computer loaded with specialty conferencing software that can exchange text, audio, and video with the server 200, among others. The internet connection of the client computer can be any form of residential or business high speed internet connection of no particular preference, fixed line or mobile high speed such as WiMAX. During a conference, the clients 110-140 and server 200 constantly exchange signals and media streams as illustrated as up stream and down stream from the clients' standpoint. Up stream refers to the client being uploading its text, audio, video, and document images on to the server, the down stream refers to the client being downloading text, audio, video and document images that are generated by other clients. The up stream and downstream can be transmitted over a peer to peer method too, in this particular embodiment, a server-client architecture is illustrated.

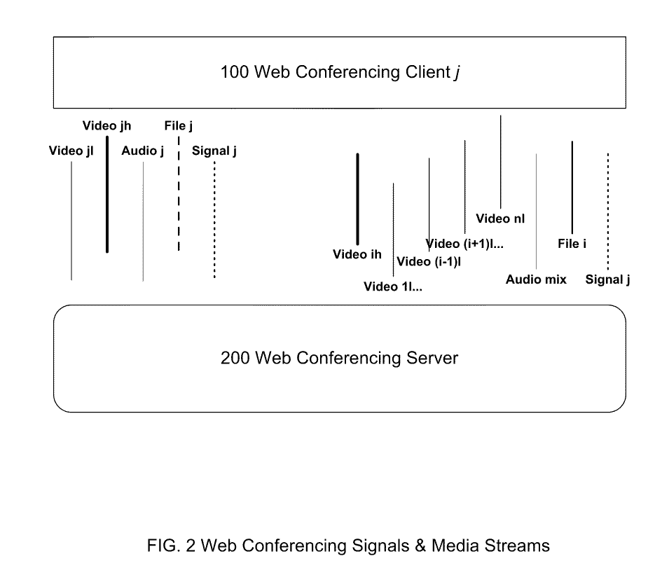

FIG. 2 illustrates the signals and media streams exchanged between any single client j 100 and the server 200 during a web conference. The upstream channels of client j 100 to server 200 include a signal channel (signal j) to server 200. The signals exchanged are protocols and control signals to command all functions of a conference from start to end. The media streams include a file sharing stream to server 200 in the event that client j 100 is the host that uploads its local file to server for other clients to view remotely. An audio stream of audio j 100 is sent from client j to server 200 in the event client j is a host of conference or is allowed to speak during the conference. A video jl is a video stream of low quality and low frequency of client j sent to the server 200; video jh is a video stream of high quality and high frequency of the same client j sent to the server 200. In the system, each client j sends two video streams, one of higher quality and one of lower quality of its video images, to conferencing server 200. The video images can be captured by one method without quality difference, however, when the video images are unified captured locally on client j, they can be processed into two streaming outlets of higher quality, higher frequency and of lower quality, lower frequency. The client can also employ two separate capturing methods to directly capture video images of higher quality and lower quality, and then send the two streams separately to server 200. In both embodiments client j has produced and sent 2 streams of its video images to server 200, and the server 200 will decide which one of the streams to send to any other client depending on the client's selection of primary participant to display.

The signals and media streams from server 200 to client j, there is a signal channel signal j from server 200 to client j, there is also a file sharing stream file i from server 200 to client, which is the file of participant i streamed to every clients including client j. A mixed audio stream from server 200 to client j is also in place to stream audio mix of some participants to client j. Now it comes to the multiple video channels from server 200 to client j, they include low quality video channels of each client 1l, client 2l, . . . client (i−1)l, client (i+1)l, . . . and client nl, and one high quality video channel of client ih, in which client i is the client ID that client j chooses to display a larger, high quality, high frequency video.

In one embodiment of the invention, each client will send a high quality video stream of its own images plus a low quality video stream, and each client will receive and display a high quality video stream of one participant of his choice, and low quality video streams of all other participants. The high quality and high frequency is relative to the low quality and low frequency, and they can be any range that are generally acceptable for a web conference. For instance, a high quality video can be the 1.1 level of H.264 with the size of video image of 320*240 and transmission of 10 frames per second, which will make the video throughput of 192 Kbps. The low quality counterparts can be the 1 level of H.264 baseline profile of 128*96 and transmission of 1 frame per second, which makes the video throughput of 3 Kbps in this example. Although one can argue that 320*240 with 10 FPS isn't exactly the high quality video, this is high quality in comparison with the low quality counterpart at 1 FPS. In practice, any combination of image size, resolution, transmission can constitute high quality as long as it has a lower quality comparative, and are perceived acceptable by conference participants to be high quality for the purpose of conducting web conferencing and file sharing sessions.

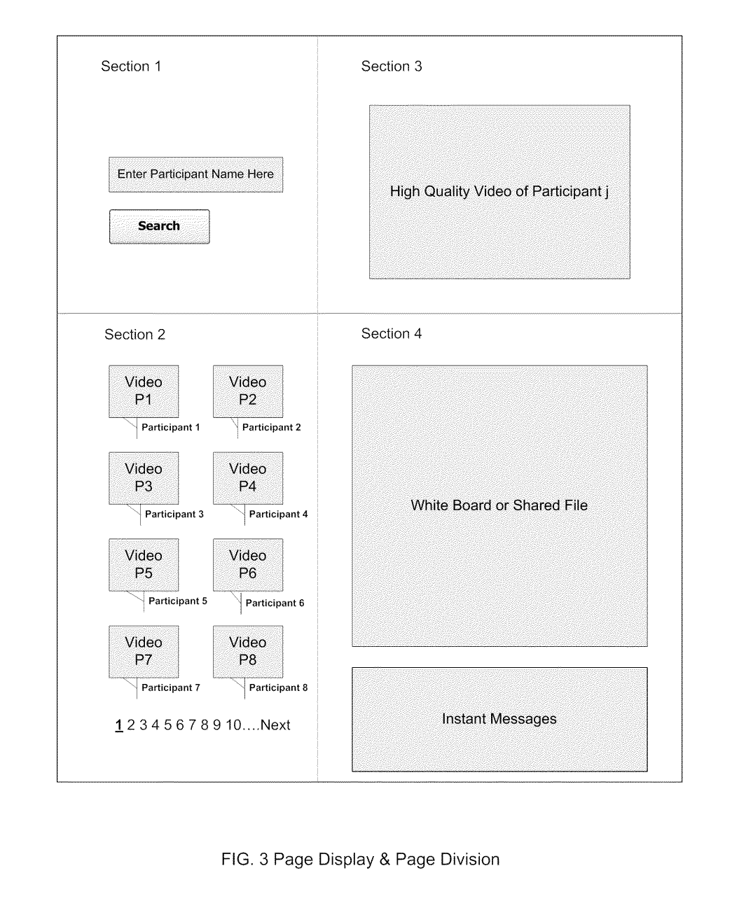

FIG. 3 is an exemplary layout illustrating page display and page division technique for web conferencing. Each conferencing client will display a graphic user interface in form of pages as shown in FIG. 3. Each page contains only a subset with a selected number of participants and their video images, in this specific illustration, each page contains one large sized video image of one selected participant, and a few (in this example eight) small sized video images of corresponding participants. The number of participants in a page can be varied. If there are more participants than one page can display, they will be allocated into more subsequent pages in any particular or random order, which can be viewed, searched, and selected by a participant to jump over to any particular page. For example, if the conference has 100 participants and each page can display 9, then the system allocates them into 12 pages. A participant can flip through the pages one by one to display the participant or group of participants of his interest. In a preferred embodiment, section 1 in FIG. 3 is a search box, a participant can enter the name of other participants to display the video image on section 3. Section 3 is a larger video image of a participant who is the host of the conference by system default setting, or is the participant chosen to be displayed on a page. Section 2 is a list of participants and their respective video images of smaller sizes and lower quality. Below each video image is the name of the participant, when the video image or name is clicked (selected), it triggers an signal to the server to stream the larger video of the participant selected, therefore the server will serve the larger video of the selected participant j to this client. Section 4 is a zone to display the shared document or computer screen, or a white board of the conference host or file host during the conference. The lower zone of section 4 is a window to display all the instant messages exchanged between participants during this conference. FIG. 3 illustrates one way of display one larger video image with many smaller video images in a page and multiple pages being used to accommodate a plurality of conferencing participants. It is obvious for anyone with ordinary skills to vary, alter, or modify the layout with the same principle of combining larger, higher quality video images and smaller, lower quality video images in a page, and divide multiple conferencing participants into multiple user interfaces (pages).

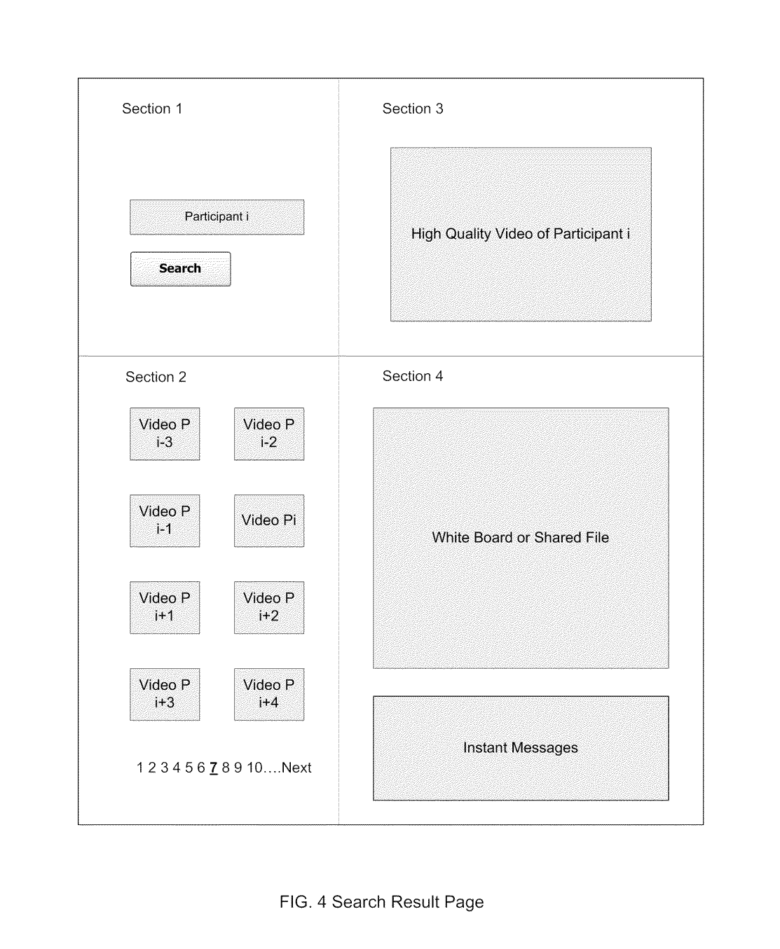

FIG. 4 shows an exemplary user interface for a participant search dialog. When a participant i is searched by a user, the server will look up the list of participant, locate the participant and locate the page for the participant. The server streams the entire page where the searched participant i is located, and displays a large video image of participant i. When a different participant is searched, the same process takes place another time, the server locates the participant and feed the entire page containing this participant to the client that performs the search, with a larger video image of the participant being searched in section 3.

The dual streaming of videos of higher quality and lower quality, and the page division technique, can provide significant savings on internet bandwidth and significant improvement on streaming efficiency. Taking a 100-participants conference as an example, if the above techniques are not in place, each client will send 1 stream of his own video and receive 99 stream of videos of the rest participants, as discussed above, if one stream of video of reasonable quality consumes 192 Kbps bandwidth, 99 streams will consume 192 Kbps*99=19,008 Kbps=19 Mbps. Therefore each client would need to upload at 192 Kbps which is still feasible for most of the residential and office high speed internet access that offers 384 Kbps-1024 Kbps uplink speed nowadays, and download at 19 Mbps which is not feasible for most of the high speed internet access which offers 1024 Kbps-2048 Kbps nowadays. In contrast, with the dual streams technique, e.g. only one video stream is of high quality (192 Kbps) and all the rest are of low quality (3 Kbps), each client will upload at 195 Kbps (192 Kbps+3 Kbps) which is low bandwidth, and download at 489 Kbps (3 Kbps*99+192 Kbps) which become also feasible with a regular high speed internet access. Through the page division technique, for example, the system divides 100 participants into 10 pages, each page with only 10 participants, thus the client only receive video streams of 10 participants at any time (1 high quality+9 lower quality), and whenever the user chooses a different page, the client will signal the server to receive the stream of selected page consisting of 10 different participants, therefore in any given time the client receives only 10 video images of 10 participants while attending a 100-participant web conference. The bandwidth consumption would be 195 Kbps (192 Kbps+3 Kbps) for uplink, and 219 Kbps (3 Kbps*9+192 Kbps), which is much better and practically doable with most of the regular home internet access.

The two techniques have even greater impact on server in regards to bandwidth consumption and streaming efficiency. For a 100-participants web conference, without the above two techniques in place, the server would stream 99 video images to each client, making the total bandwidth consumption of 99*100*192 Kbps=1,900,800 Kbps=1.9 Gbps. This level of bandwidth consumption is forbidden for most conference service providers nowadays. With the first technology of dual streams, the server will stream 1 high quality video plus 99 low quality video to each client, making the bandwidth consumption of 192 Kbps+(99*3 Kbps)=489 Kbps for each client, the total bandwidth for 100 clients will be 48,900 Kbps=49M kbps. The server also receives a total of 100 high quality video (192 Kbps*100=19,200 Kbps=19 Mbps) and 100 low quality video (3 Kbps*100=300 Kbps=0.3 Mbps), which makes its receiving stream at 19.3 Mbps. Therefore, the total sending plus receiving streams will consume a total bandwidth of 68.3 Mbps, this is a lot less than the significant 1.9 Gbps. Applying the page division technique, the server only needs to send 10 streams to each client (1 high quality+9 low quality) which consumes 192 Kbps+(9*3 Kbps)=219 Kbps for each client. For 100 clients the total sending consumption will be 21,900 Kbps=22 Mbps in total. Now adding the receiving bandwidth of 19.3 Mbps, the total bandwidth consumption of a server is 41.3 Mbps, which saves another 27 Mbps if there were not page division technique. And although 41.3 Mbps is still a big number, it falls into the manageable range of servers with 100 Mbps network interface (which most servers equipped with) and bandwidth arrangement (majority with 100 Mbps network over a CAT5 Ethernet Cable).

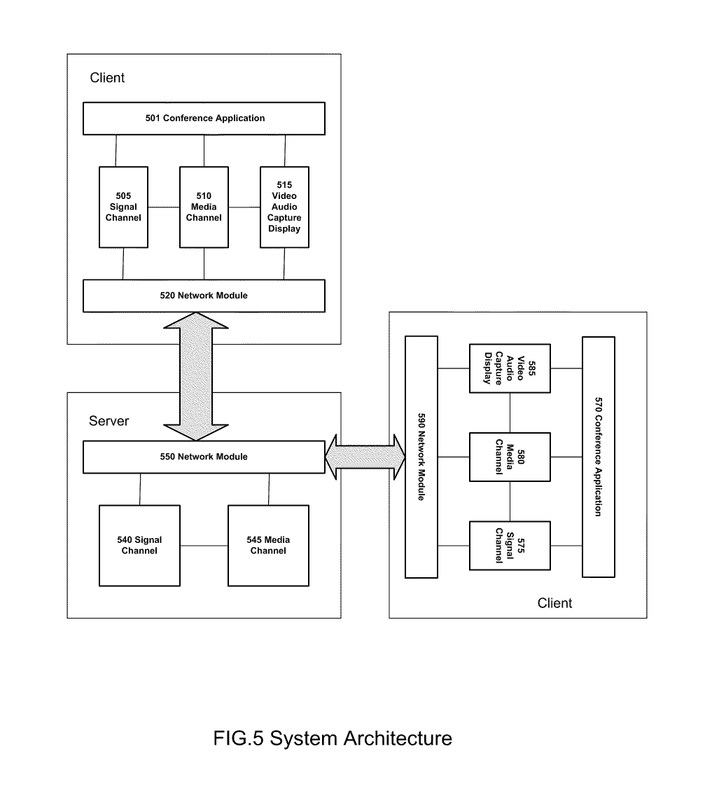

FIG. 5 is a system architectural diagram illustrating the building blocks of web conferencing system. In this embodiment the conferencing server is located in internet datacenter. Its role is to command and conduct the conference by exchanging signals and media with all conferencing clients over the internet. The server contains a signal channel 540 to exchange conferencing signals with all clients, it also contains a media channel 545 to exchange media with clients, the media types include text, audio, video, and file images. It also has a network module 550, which role is to monitor and exchange network status with all clients to ensure that the conference sessions synchronized among all clients (participants). The synchronization method will be described in details in following paragraphs.

The client, broadly speaking, is any internet user with a web conferencing device or application and is a participant of the conference. The client contains a conference application 501 which is the software that drives or controls the conferencing hardware such as webcam or headset; a signal channel 505 that exchanges signals with its corresponding channel 540 on server end; a media channel 510 that exchanges media with its corresponding channel 545 on server end; a network module 520 to synchronize sessions with its server counterpart 550. In addition, the client is equipped with video and audio capturing and display module 515, its function is to capture the participant's video image and audio wave from local computer, and to display the video for the participant.

The signal channel is used to organize and control a conference with the signals such as participants login and logout, request for speaking, permit of speaking, ban of speaking etc. As explained above, the uplink media carry two video streams and one audio stream of mixed sound. One video stream is of high quality and high frequency and the other is of low quality and low frequency; the downlink media carry one high quality video and many streams of low quality of the rest participants, as well as an audio stream of mixed sound. The media channel is also compressing and decompressing video and audio.

The network module monitors the signals and media it receives through its interface. It reserves, requests, and observers the bandwidth and report it. Based on the report, the network module selects the proper media compression ratio. The network module also monitors and reports the conferencing session IDs that flow through its interface. In addition, the conference application can implement some logics, like setting up host, and empower the host to activate the audio capability of any clients etc.

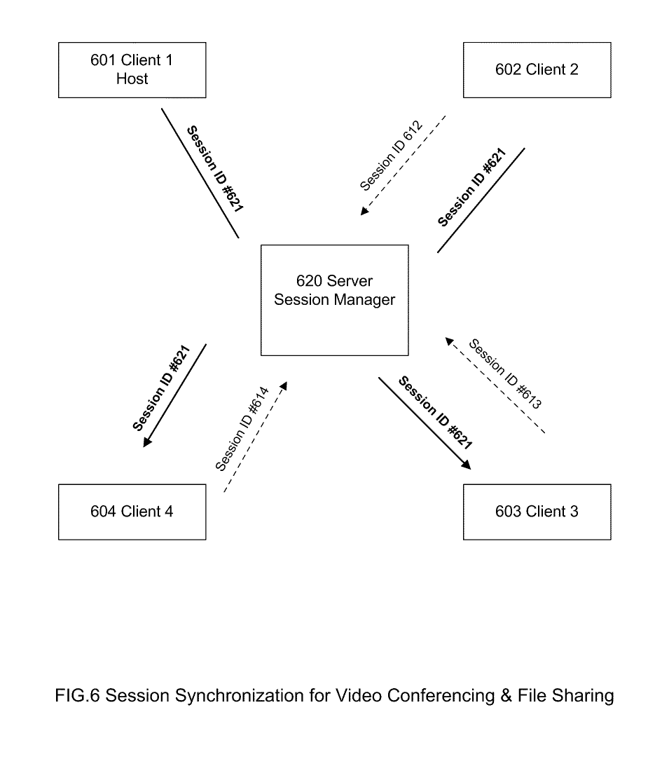

FIG. 6 is a diagram illustrating the session synchronization method for file sharing and video conferencing. In some applications like distance learning or team collaboration, participants need to view the same video or file images uploaded by the host. In practice, due to the various network conditions and client capabilities, different participants often receive different video and/or file images, sometimes even different sessions of audio waves. For example, in a design conference participated by team members distributed around the world, the conference host 601 client 1 located in USA may upload a serial of drawings for the team to discuss one by one. While the conference host may flip to drawing #621, 602 client 2 may receive the same drawing #612 images streamed to him as he is located in China, where a noticeable network delay exists from/to USA; 603 client 3 may still receive image streams of drawing #613, as he is located in UK with some network delays from/to USA but better than that of China; 604 client 4 may receive image streams of drawing #614 as this client is located in Canada with faster network speed from/to USA. Although to different extents, all 3 clients are lagging behind the host in receiving the current video/file images, which cause an effective conference to be impossible as participants are not on the same page. In one embodiment of the present invention, a session synchronization module is introduced and embedded in the network module of both clients and server. Media streams are tagged with series of session IDs, 601 client 1 host will constantly report its session ID being streamed to the server, and each client 602, 603, and 604 will also report the server the session IDs they are receiving respectively. The server 620 will compare the session ID each client is receiving with the session ID the host 601 is sending, if the discrepancy is within the tolerance, the server 620 will stay idle without any interference; if the discrepancy, either individual or collective discrepancy fall out of the tolerance, the server 620 will start to interfere, in one embodiment of such interference, to drop the ongoing streams to each respective clients, and to pick the most updated session ID streaming to the clients lagged behind. This is one way to make sure that everyone in the conference is on the same page. Other ways of synchronization can be done, including that, to alert host 601 and to suggest a slower page flip speed, or to enforce a maximum page flip speed or upload speed on host 601 according to the various network conditions reported by each clients.

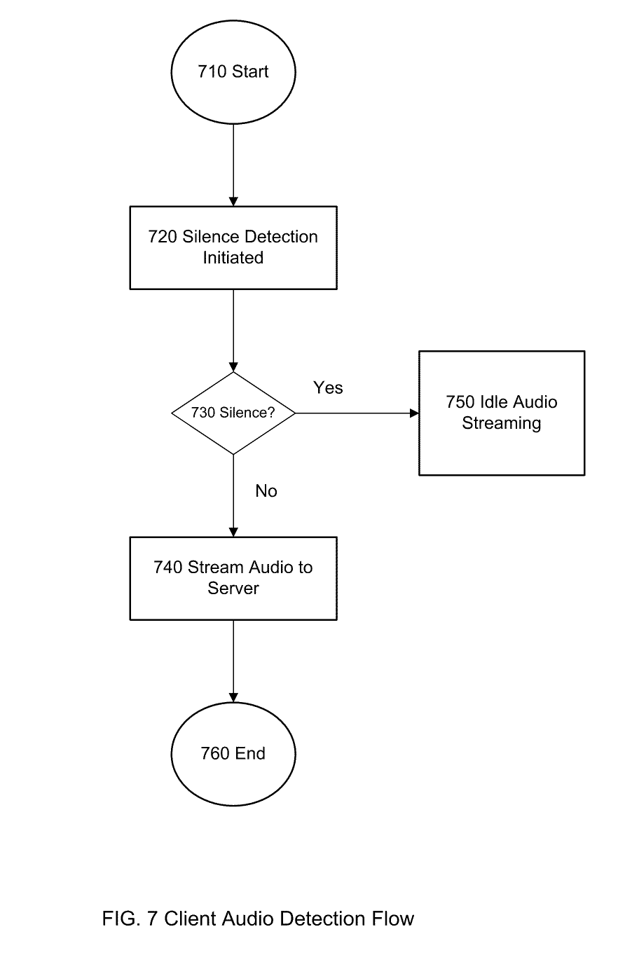

FIG. 7 is a flow diagram illustrating the audio detection function on each conferencing client. This function is embedded within the conference application module 501 in FIG. 5 When a client turns up the conferencing application as step 710, the silence detection module will be turned on as shown in step 720, if a silence is detected as shown in step 730, the audio streaming module will be put idle to save bandwidth consumption and streaming capability; only until an audio wave is detected (silence not detected), will the audio streaming module be turned on and started streaming. In practice this method can improve bandwidth consumption and processing capability, since in any conference the listeners will constitute a majority of participants who remained silence most of the time, therefore no need to turn up streaming module to stream “silence” for them.

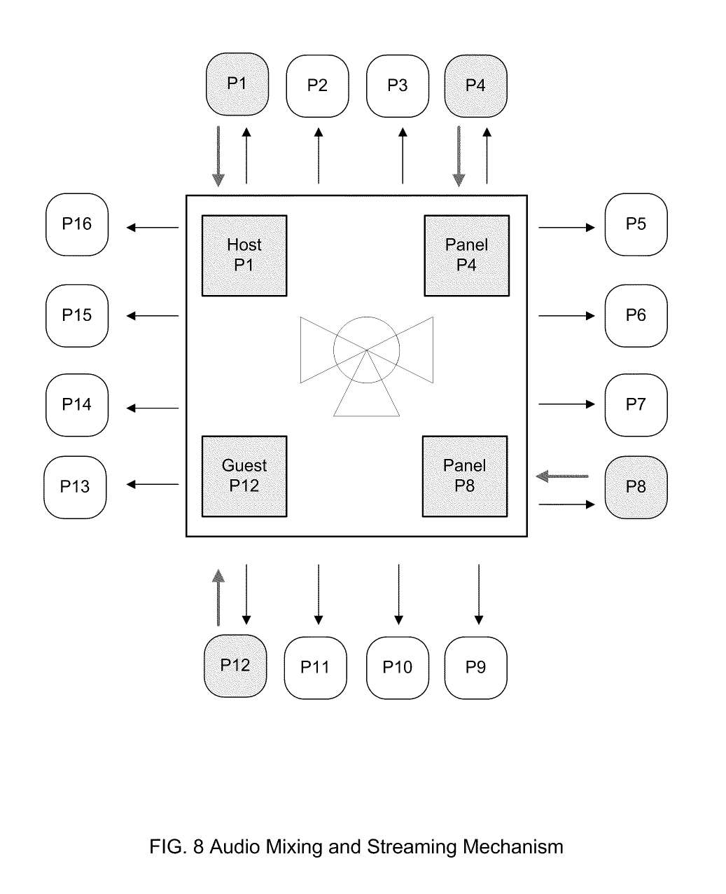

FIG. 8 is a layout diagram illustrating the audio mix and streaming method of the present invention. One aspect of the method is to only allow very few participants to speak at any time during a conference, they can organize a panel discussion with, for example, 4 panel members with voice capability. Although there can be many conference participants, it makes no practical sense to allow everybody to speak, in which event the conference will become a noisy marketplace. The method for an internet-based web conference is to only allow the host can speak, and all others are listeners, or only a very few panel members can speak, all others are listeners. In FIG. 8 there are 16 participants illustrated, but only 4 participants are permitted to speak, e.g. with their audio streaming module being turned up. The selection mechanism can be that the conference host choose who can be the panel member besides himself, or other similar mechanisms. In FIG. 8, Host P1 is chairing the conference and is the incumbent speaker, P4, P8, P12 are selected as panel members and go into the inner circle of speakers, the 4 panel members can speak and debate, their audio waves will be mixed in conferencing server as one audio stream, and this one audio stream will be streamed to each and every conferencing participants over the Internet. The method of limiting the number of speakers, mixing their voices in server and then streaming the mixed audio as one stream help saving the processing load of central processing unit (CPU), as well as saving bandwidth when streaming.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the merchant web site 130 is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer). Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to provide video conferencing, comprising:
a. receiving at a server a plurality of video streams or audio streams from a plurality of clients;
b. selecting a subset of video streams or audio streams to be rendered in a conferencing display screen;
c. providing access to the remaining participants through one or more links to one or more additional display screens; and
d. sending only streams of the subset to a client to avoid transmissions of the remaining streams.

2. The method of claim 1, comprising sending from the server to each client one high quality video stream and a plurality of low quality video streams.

3. The method of claim 2, comprising sending a high quality video stream at a high frequency to enhance video quality.

4. The method of claim 2, comprising sending a low quality video stream at a low frequency to reduce bandwidth requirement.

5. The method of claim 1, comprising selecting at the client one participant's high quality video stream.

6. The method of claim 5, comprising displaying at the client the low quality video for the remaining participant.

7. The method of claim 5, comprising clicking on a link to access videos of participants on a second screen.

8. The method of claim 7, comprising displaying the selected participant's high quality video with one or more low quality videos of participants on the second screen.

9. The method of claim 1, comprising clicking on a link to access videos of participants on another screen.

10. The method of claim 1, comprising searching for a selected participant and displaying a screen containing the stream of the selected participant.

11. The method of claim 1, comprising detecting audio silence at the client and not transmitting the client's audio stream to the server.

12. The method of claim 1, comprising detecting a video still at the client and not transmitting the client's video stream to the server.

13. The method of claim 1, comprising streaming a document to the server for document sharing.

14. The method of claim 1, comprising periodically labelling each video stream or document sharing stream with a session identifier (ID) to synchronize the conference video streams.

15. The method of claim 14, wherein each client periodically reports the session ID being streamed to the client, and wherein the server compares a received session ID with a session ID uploaded by the client.

16. The method of claim 1, wherein the server sends a correct session ID to a client whose session ID exceeds a pre-determined synchronization tolerance.

17. A video conferencing system, comprising:
a. a plurality of clients, each generating an audio or video stream; and
b. a server to receive the streams from the plurality of clients, the server selecting a subset of streams to be rendered on a video conferencing display screen and sending only streams of the subset to a client to avoid transmissions of the remaining streams.

18. The system of claim 17, wherein the server receives a plurality of high quality and low quality video streams from the plurality of clients and sends to each client one high quality video stream and a plurality of low quality video streams.

19. The system of claim 18, wherein the server sends the high quality video stream at a high frequency to enhance video quality and wherein the server sends the low quality video stream at a low frequency to reduce bandwidth requirement.

20. The system of claim 17, wherein the server provides access to the remaining streams through one or more links to one or more additional display screens.
